(19) United States
(12) Patent Application Publication
(10) Pub. No.: US 2026/0009372 A1
(43) Pub. Date: Jan. 8, 2026

(54) SYSTEM FOR GENERATING WAVE ENERGY IN DEEP WATERS INCORPORATED INTO THE FLOATING PRODUCTION, STORAGE AND OFFLOADING UNITS AND ASSOCIATED CONSTRUCTION METHOD

(71) Applicant: Petróleo Brasileiro S.A. - Petrobras, Rio de Janeiro (BR)

(72) Inventor: Allan CARRE DE OLIVEIRA, Rio de Janeiro (BR)

(73) Assignee: Petróleo Brasileiro S.A. - Petrobras, Rio de Janeiro (BR)

(21) Appl. No.: 19/249,860

(22) Filed: Jun. 25, 2025

(30) Foreign Application Priority Data
Jul. 3, 2024 (BR) 10 2024 013676 4

(51) Int. Cl. F03B 13/24

(52) U.S. Cl. CPC F03B 13/24; F05B 2220/706

(57) ABSTRACT

The disclosed relates to systems and methods for generating wave energy incorporated into the floating production, storage and offloading units, which comprises: one or more energy extraction chambers arranged on sides of a floating production, storage and offloading unit; each energy extraction chamber having a lower opening being obtained from removal of a bottom plate of the chamber to provide fluid communication between the interior of the chamber and the seawater; an upper opening made at the top of the chamber for passage of air flow; and an energy generation assembly for converting air flow from the opening into electrical energy; wherein each air chamber is obtained by widening a ballast tank in the direction opposite to the center of the unit to create a resonance condition in the chamber so that a final chamber widening width is determined based on a resonance period of interest of the chamber.

### CROSS-REFERENCE TO RELATED APPLICATION

This application claims priority to Brazilian Patent Application No. 10 2024 013676 4, filed Jul. 3, 2024, the entire contents of which is incorporated herein by reference.

### FIELD OF THE DISCLOSURE

The present invention is applied in the field of technologies that generate renewable energy and, more particularly, the main field of action of the present invention is in methods and systems implemented in floating production, storage and offloading units (Floating Production, Storage and Offloading Unit-FPSO), in the process of decarbonizing the oil production offshore, to generate renewable energy from waves, in order to supply part of the FPSO's electrical demand.

### BACKGROUND OF THE DISCLOSURE

A system for extracting energy from waves according to the concept known as Oscillating Water Column (OWC) consists of an air chamber above the action of the waves. This chamber consists of a compartment with an open bottom in the marine environment. Inside the chamber, the seawater oscillates and this oscillation can be used to move a piece of equipment that converts this movement into electrical energy.

In the most common arrangement model for this type of structure, the chamber has a reduced cross section at its top, in order to accelerate the air flow forced by the movement of the waves inside the chamber, with this air flow being directed to a Wells turbine, which converts this oscillatory movement of the air into rotary movement for an electrical generator, as seen in FIG. 1.

In FIG. 1, it can be seen that, depending on the size of the chamber and the period of the incident wave, there is an amplification of the wave elevation inside a circular chamber with diameter D and depth L, an effect that is represented by the difference between the height of the wave H and the height observed inside the chamber Hc. This type of effect is known in the offshore industry, having been observed several times on drilling platforms, which have openings in the hull, called moonpools, for the passage of the drilling/completion riser. On drilling platforms, this amplification of the waves inside the moonpool is an undesirable effect and research is being carried out to minimize these effects. For the extraction of wave energy, however, amplification is positive, as it allows for an increase in the recovery of energy from the apparatus.

The OWC concept is generally known as the most efficient system for generating wave energy, but, currently, both its fixed configurations and its floating unit configurations are more commonly designed for shallow waters (ocean depth between 0 and 300 meters).

In deep waters (over 300 meters of ocean depth), there are systems that use the OWC concept combined with wind energy. This type of system is known as a hybrid system. The proposal for hybrid systems is due to the high cost of energy due to the investment required, since a floating wave energy capture system requires the construction of the hull and the anchoring system and the cable system to transmit this energy to the consumer source.

In addition, a difficulty associated with implementing systems based on the OWC concept in deep waters is due to the variation in the direction of incidence of the waves, which does not exist on the coast, since the waves align with the coastline. In this way, the design of the chamber needs to be changed in order to be efficient, receiving waves from different directions.

Other associated difficulties relate to the high costs involved in the support structure of the wave generation system and the construction time of the elements to make the operation viable (for example, construction of the hull and the anchoring system and the cable system to transmit this energy to the consumer source, which may be several kilometers away from the system).

Accordingly, in view of the problems and deficiencies of the state of the art in this field, there is a need to develop a system for generating wave energy in deep waters incorporated into the floating production, storage and offloading units (also called “FPSO-type units” in the present invention) that is capable of: —generating energy efficiently and cleanly to be consumed by the FPSO itself, reducing its own energy consumption from non-renewable sources; —also reducing the time for designing and constructing new structures for implementing the technology in deep waters, not to mention the construction of anchoring assemblies specific to this energy generation structure; and —adapting FPSO-type units in a simple manner, without complexity in terms of the use of materials and labor.

The state of the art shows some documents that disclose matters within the technological field of the present invention.

Document KR101372480B1 relates to a wave energy generator utilizing a retired/abandoned ship that generates electrical energy by introducing seawater into a cargo hold or tank of a retired ship that communicates with the outside and driving a turbine using an air flow by a vertical movement of the introduced seawater, thus effectively recycling the retired ship and generating alternative energy efficiently. The wave energy generator utilizing a retired ship according to said document comprises: an opening portion formed in the side or bottom of a compartment of a retired ship to be communicated with the ocean floor so that seawater flows freely into and out of the compartment; a turbine that is mounted in a ventilation hole formed in the upper surface of the compartment to be communicated with the outside and that is rotated by air that flows freely into and out through the ventilation hole by the upward and downward movement of seawater; and an energy generator that generates electrical energy by rotating the turbine.

Thus, document KR101372480B1 makes use of a tank from an abandoned ship for the purpose of extracting wave energy. The present invention differs from the disclosure of document KR101372480B1 for at least a few reasons. A first difference concerns the tanks that are used to form the chambers and generate the waves. The present invention uses wind tanks from a floating production, storage and offloading unit (used as ballast t tanks for the platform), while in document KR101372480B1 more central tanks are used, relating to the vessel's cargo tanks (ship ballast tanks are generally smaller than those of FPSO-type units). Document KR101372480B1 even mentions that the cargo tanks may be accumulating oil or liquefied natural gas (LNG).

The choice to use ballast tanks in FPSOs, as in the present invention, is related to the issues of not losing cargo storage capacity or static stability. Document KR101372480B1 does not disclose or suggest that a ballast tank should be used instead of a cargo tank to design a chamber, which would lead a person skilled in the art in a direction opposite to that intended by the present invention.

In addition, the technical features of the present invention increase the efficiency of its system, which cannot be said about the aforementioned document. This issue is directly related to the (very large) size of the chamber adapted from the cargo tank in document KR101372480B1, which causes the resonance period of the chamber (a function of the surface area of the water inside the chamber and of the depth of the same, so that the larger the waterline area and the depth, the greater the resonance period of the chamber) to end up being large, which is detrimental in terms of energy recovery.

Furthermore, document US20100229545A1 describes a method and apparatus for extracting energy from wind and wave motion using a common floating platform comprising a ship hull that is moored at an offshore location and that supports wind turbines to extract energy from wind and wave energy extraction devices positioned at least on one side of the hull to extract energy from wave motion relative to the hull. The method and apparatus may also use water stream energy extraction devices. The hull may also support a desalination plant that uses energy generated from wind, wave and water stream energy extraction devices.

Document US20100229545A1, as well as KR101372480B1, discloses the use of wing tanks for conversion into resonance chambers for extracting wave energy. In addition, the physical principle used by document US20100229545A1 to generate energy depends on greater movement of the vessel in a resonant condition to cause more air to pass through the turbine, generating more electricity, a concept distinct from the present invention, which sizes the air chamber to be resonant with the sea condition or with the resonant movements of the ship to “steal energy from its movement” by the principle of dynamic vibration damping to amplify the amplitude of the wave in the region of the wave energy extractor. Additionally, document US20100229545A1 converts the outermost plate of the ship's side into a movable wall with a float at the end, so as to have a type of flap increasing the air flow through the turbine opening.

Document WO2012117135A1 refers to a floating structure for harnessing wave energy, said structure comprising a plurality of independently oscillating water column (OWC) chambers aligned and open at the lower portion, each chamber communicating with the atmosphere through the upper portion by means of a turbogenerator group formed by an air duct containing a valve for controlling the air flow and a self-rectifying air turbine connected to an alternator.

However, document WO2012117135A1 discloses a system applied to the generation of wave energy in shallow waters. In addition, said document does not disclose or suggest the use of tanks designed to minimize the movements of the FPSO-type unit and function as a dynamic vibration absorber.

Furthermore, document KR20160077955A refers to a ship having an energy generation system, and more specifically, to a ship having an oscillating water column (OWC) type energy generation system, which generates energy using the air flow that flows according to the change in ballast water level generated due to the rolling of the ship, generating electricity while controlling the rolling of the ship.

However, document KR20160077955A addresses to an active system for controlling the roll movements of a ship by pumping ballast from one wind tank to another. Further, the system of the present invention differs from that proposed by document KR20160077955A in that while the system of the present invention is passive, and therefore does not depend on electrical energy to operate, the system of KR20160077955A is active, as it depends on the pump for its operation. The system of the present invention, in the case of maximizing wave energy recovery, works on sizing the tanks to be resonant in the most frequent wave period or in vertical modes, making the chambers dynamic vibration dampers (or movements in the case of the ship), which is not the case in document KR20160077955A.

Additionally, document WO2024042453A1 refers to an apparatus for extracting energy from an oscillating working fluid. The apparatus comprises a housing that is positioned on a floating support structure that is arranged for use to float on a body of water with waves. The housing has an internal flow passage for receiving air; and a turbine that is arranged in the housing.

However, the teachings of said document are more applicable to catamaran-type vessels and not to the FPSO-type floating units, so that document WO2024042453A1 further aims at designing a new (cylindrical) tank instead of using the vessel's own tank, as is the case with the present invention.

### SUMMARY OF THE DISCLOSURE

Considering that the state of the art lacks systems and methods implemented to generate wave energy in deep waters efficiently and with low complexity and cost, the present invention aims at developing a system based on the hull of a FPSO-type floating unit in deep waters, wherein ballast tanks are designed to maximize the wave energy recovery, making the hull design different from a traditional box-shaped FPSO. The present invention takes into account that the deep water scenario has greater energy potential, but lacks a source of electrical energy consumption, which is supplied by the FPSO itself where the system of the present invention is built.

In addition, the system developed by the present invention is applied based on the principle of a dynamic vibration absorber in a passive mode in a scenario of minimizing movements and generating energy from the FPSO-type floating unit.

The system of the present invention, by being applied to a FPSO-type floating unit, considerably reduces the cost of the floating structure of the wave energy generation platform, since, in this case, the cost would correspond only to the proposed modifications to the FPSO structure, which are relatively small in terms of material.

In addition, the incorporation of the system of the present invention into an FPSO eliminates the need for an anchoring assembly for the system, as the FPSO anchoring assembly would already contain the platform naturally and, finally, would eliminate the need for a transmission cable for the export of this energy, since the FPSO itself is the structure responsible for consuming the energy produced (self-sustainability).

Accordingly, the advantages and objectives of the present invention are achieved by providing a system for generating wave energy in deep waters incorporated into the floating production, storage and offloading units comprising: one or more energy extraction chambers arranged on the sides of a floating production, storage and offloading unit; each energy extraction chamber having a lower opening, the lower opening being obtained by removing a bottom plate from the chamber to provide fluid communication between the interior of the chamber and the sea water; an upper opening made at the top of the chamber for the passage of air flow; and an energy generation assembly for converting air flow from the opening into electrical energy; wherein each air chamber is obtained from a ballast tank of the production, storage and offloading unit by widening said ballast tank in a direction opposite to the center of the unit to create a resonance condition in the chamber, so that a final chamber widening width is determined based on a resonance period of interest of the chamber.

In addition, in one embodiment, the present invention includes a method of constructing a system for generating wave energy in deep waters incorporated into the floating production, storage and offloading units, wherein the method comprises: widening one or more energy extraction chambers arranged on the sides of a floating production, storage and offloading unit; removing a bottom plate from the chamber to provide fluid communication between the interior of the chamber and the seawater; making an opening at the top of the chamber for the passage of air flow; and assembling an energy generation assembly for converting the air flow from the opening into electrical energy.

### BRIEF DESCRIPTION OF THE FIGURES

The preferred embodiments of the invention in question will be better understood when read in conjunction with the accompanying drawings. It should be understood, however, that the invention in question is not limited to the precise arrangements and instruments shown.

Thus, the present invention will be described below with reference to its typical embodiments and also with reference to the appended drawings, in which:

FIG. 1 shows a schematic view of an OWC-type wave energy generation apparatus, according to the state of the art.

FIG. 2 shows a schematic view of a typical cross section of a conventional FPSO-type floating unit, according to the state of the art.

FIG. 3 shows a typical configuration of the tanks of a FPSO-type floating unit in a three-dimensional view, according to the state of the art.

FIG. 4 shows a cross section of a modified FPSO-type floating unit representing the deepwater wave energy generation system incorporated into the floating production, storage and offloading units, according to an embodiment of the present invention.

FIG. 5 presents an example of wave energy calculation inside energy extraction chambers for the same sea state, where it can be seen that the resonance period closer to the sea state allows the extraction of greater wave energy.

FIG. 6 shows a configuration of the tanks of a system applied to the FPSO-type unit in a three-dimensional view, according to an embodiment of the present invention.

FIG. 7 presents a comparison of the typical cross section of a conventional FPSO-type unit with the cross section of the system applied to the FPSO of the present invention.

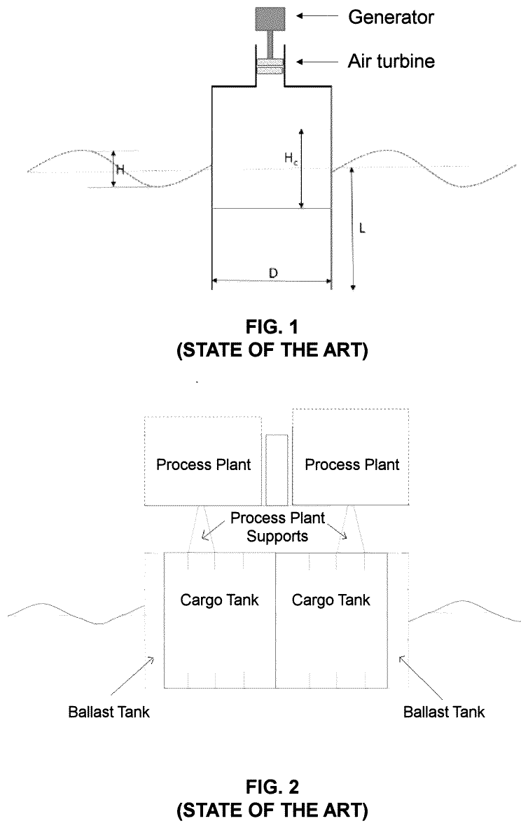

### DETAILED DESCRIPTION OF THE DISCLOSURE

Below, reference is made in detail to the preferred embodiments of the present invention illustrated in the attached drawings. Whenever possible, the same or similar reference numerals will be used throughout the drawings to refer to the same or similar features. It should be noted that the drawings are in simplified form and are not represented to a precise scale, so that small variations are anticipated.

The present invention relates to a system for generating wave energy in deep waters incorporated into the floating production, storage and offloading units, as well as to a method of constructing this system.

Notably, for the extraction of the wave energy in deep waters, the embarkation of the system developed by the present invention on an FPSO eliminates the need to construct a floating support structure (since the FPSO plays this role), reducing implementation time and costs. In addition to the support structure, a deep water wave energy extraction platform would also need an anchoring assembly to keep it in a given location (which is also already present in the system applied to an FPSO of the present invention). Finally, a deep-water wave energy production system would require an energy transmission system to the coast, which would not be necessary in the system applied to the FPSO of the present invention, since the FPSO-type floating unit itself would be the source of consumption of this energy.

Thus, the present invention aims at extracting wave energy in a system applied to the FPSO by creating or modifying structures in the unit to create the air chamber. The present invention proposes a solution that requires fewer modifications to the FPSO structure, which consists of modifying some of the unit's ballast tanks to operate as wave energy extraction chambers and installing equipment that convert the movement of the air flow inside the chamber into renewable electrical energy.

FIG. 2 shows a typical cross section of a conventional FPSO. In this figure, it is possible to observe the cargo tanks for storing the oil produced by the unit and the conventional ballast tanks, which can store seawater depending on the unit's cargo to aid in its balance or can be empty, serving as a buoyancy reserve for the unit. It is also possible to observe process plants supported by their supports. Both the cargo tanks and the ballast tanks are leak-proof, that is, they are closed, with no communication with the outside environment, and can only be loaded and unloaded by opening/closing intake valves and pumping fluids (oil to the cargo tank or seawater to the ballast tank to fill or empty the tank).

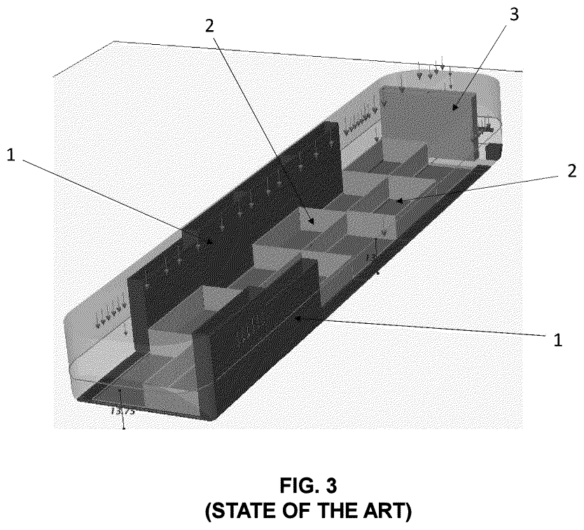

FIG. 3 shows a typical tank configuration of an FPSO-type unit in a three-dimensional view, in which the ballast tanks 1 and cargo tanks 2 are partially filled, in order to maintain the unit within a balanced condition according to its operational limits. It is also possible to visualize a diesel oil tank 3 of the unit. In FIG. 3, it can be observed that the unit has several ballast tanks 1 and cargo tanks 2 in its parallel body, a region of the hull where the cross section remains constant.

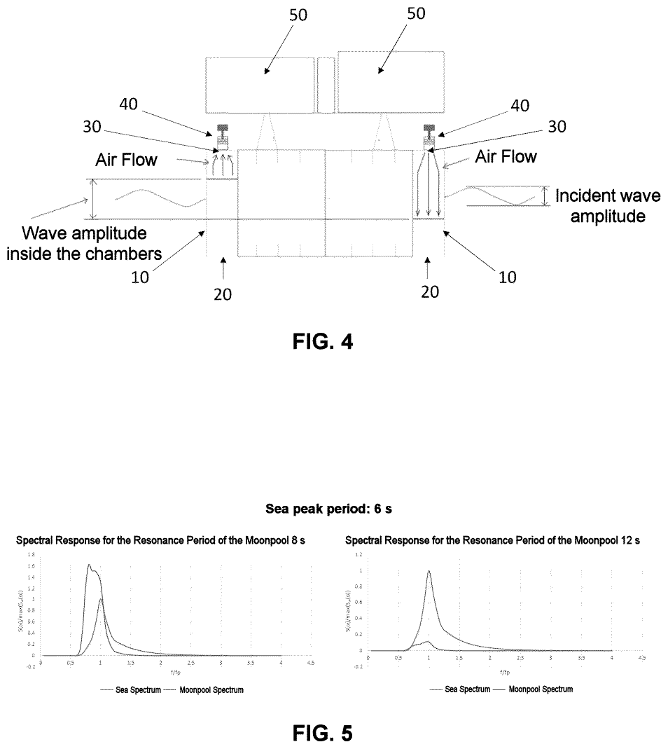

FIG. 4 shows a cross section of a modified FPSO-type floating unit that represents the system for generating wave energy in deep waters incorporated into the floating production, storage and offloading units, according to an embodiment of the present invention. The system comprises: one or more energy extraction chambers 10 arranged on the sides of a floating production, storage and offloading unit, the maximum number of energy extraction chambers 10 being limited to the maximum number of ballast tanks of the unit (if there is no loss of relevant stability by the unit); each energy extraction chamber 10 having a lower opening 20, the lower opening 20 being obtained from the removal of a bottom plate of the chamber 10 to provide fluid communication between the interior of the chamber 10 and the seawater; an upper opening 30 made at the top of the chamber 10 for the passage of air flow, reducing by at least ten times the area of the lower opening 20, limited by the operating speed of a turbine of an energy generation assembly 40, which increases as the section is reduced; and an energy generation assembly 40 for converting the air flow from the opening 30 into electrical energy; wherein each air chamber 10 is obtained from a ballast tank of the unit by widening said ballast tank in the direction opposite to the center of the unit to create a resonance condition in chamber 10, so that a final chamber widening width is determined based on a resonance period of interest of the chamber 10. The resonance period of interest of the chamber 10, or natural period of chamber 10, is equal to a period in which the unit will operate and depends on environmental conditions of the site. In this way, the wave amplitude inside chamber 10 will be greater than the amplitude outside, amplifying the air flow generated and consequently the energy recovered.

The resonance period of interest of the chamber 10 is given as a function of the surface area of the water inside chamber 10 and the depth of the water, so that the greater the waterline area and the depth, the greater the resonance period of the chamber. However, although there is a directly proportional relation between the dimensions of the chamber and its resonance period, the dimensions of a chamber should not be invariably increased in order to obtain greater energy generation. This is because very long resonance periods can be detrimental in terms of energy recovery. FIG. 5 shows, as an example, how a very long resonance case can be detrimental terms of energy recovery. In FIG. 5, the responses in terms of sea spectrum inside a moonpool (chamber) were estimated under the action of a sea state with a unitary significant height and a peak period of 6 seconds (blue curve in both graphs). In this same figure, the abscissa represents the frequency normalized by the peak frequency of the 6-second sea state. Notwithstanding, it is worth emphasizing that the graphs are normalized according to the maximum energy on the ordinate and the peak frequency of the input sea energy on the abscissa, and it can be seen that the chamber with a resonance period of 8 seconds still presents resonance (larger area of the spectrum, demonstrating more energy than the input sea energy), while the chamber with a resonance period of 12 seconds presents practically no wave energy inside the chamber, showing that a system with this configuration would not be able to extract energy from a sea with this peak period. The example in FIG. 5 aims at showing the importance of having a system designed to recover energy from waves, which is much more efficient than a system created from the conversion of a structure not designed for this purpose. Thus, not sizing the system, in addition to being inefficient from the point of view of energy recovery, can generate the opposite effect, filtering the entry of waves into the chamber (which could happen if the resonance period of the chamber is much longer than the period of recurring waves of the capacity) and, consequently, not generating energy from the waves.

In this way, the resonance period of interest of the chamber 10, in embodiments of the present invention, is defined to be a period equal to or close to the period of greatest wave recurrence at the location of the FPSO-type floating unit, in order to increase energy recovery due to this resonance. In other words, the resonance period of interest of the chamber 10 is a period of sea peak, so that the movement of the sea inside this chamber 10 presents resonance and amplifies the generation of wave energy.

Further, in embodiments of the present invention, the resonance period of interest of the chamber 10 is defined to be a period equal to or close to a resonance period of movements of the FPSO-type floating unit. The movements of the unit are one or more of: heave, roll, pitch, or a combination thereof. When the resonance period of interest of the chamber 10 is defined to be a period equal to or close to a resonance period of movements of the FPSO-type floating unit (which may vary in a range between 10 and 20 seconds, depending on the movement and design of the unit), depending on the mass ratio between the mass of the unit and the mass of water inside the chambers 10, a phenomenon known in dynamics as dynamic vibration damper occurs (in this case, called dynamic motion damper), in which the system with the lowest mass (the liquid in the chambers) amplifies its resonant response, decreasing the resonant response of the system with the highest mass (the unit).

Furthermore, it should be mentioned that removing the bottom plate of the modified ballast tank to operate as a wave energy extraction chamber means removing the tank's leak-tightness and allowing seawater to communicate with the inside of the tank (now chamber)—influx of waves inside the chamber. With the chamber 10 sized to be resonant in a period of interest, when the sea has its peak period corresponding to that period, the amplitude of the waves inside the chamber 10 will be greater than the amplitude in the external region.

In addition, the upper opening 30 made at the top of chamber 10 for the passage of air flow must be a small opening, smaller than the lower opening 20, to force an increase in the speed of the air flow through that opening. Thus, this opening will be dimensioned to ensure the best efficiency of the energy generation assembly 40.

In embodiments of the present invention, the energy generation assembly 40 comprises a turbine 41, which may be of the Wells or impulse type, and a generator 42.

Regarding the electrical energy generated, the same depends on some factors, such as the tank sizing strategy (maximize the energy generation versus minimize the FPSO capital investment), number of ballast tanks to be converted for wave energy generation, area where the FPSO will operate and its energy potential. Considering a scenario of area of operation of pre-salt of the Santos basin, for example, an electrical energy generation potential of between 10 MW and 30 MW was estimated, varying the factors described above, which would generate an estimated reduction in CO₂ emissions of between 1,400,000 t and 4,200,000 t of CO₂ during the useful life of the unit, lowering the GHG (Greenhouse Gas) Inventory of the unit in question by between 0.6 kgCO/boe and 1.8 kgCO/boe, depending on the scenario.

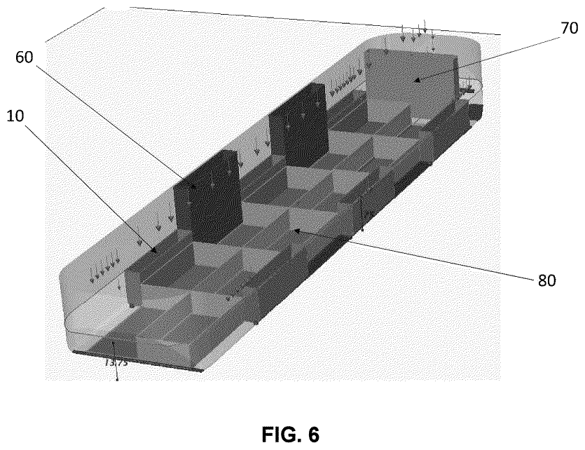

FIG. 6 shows, by way of example, some ballast tanks (six tanks in this example) of the unit that were converted into wave energy generation chambers 10. Furthermore, the ballast tanks 60 that were not converted into chambers are also shown, as well as diesel oil tanks 70 and cargo tanks 80. The number of tanks to be converted into chambers 10 depends on a prior analysis of the buoyancy reserve required for the FPSO-type unit, since removing the tank's leak-tightness removes part of this reserve, while increasing the width of the tanks generally increases the buoyancy of those tanks that are not transformed into wave energy extraction chambers 10.

Below, there is described a method of constructing a system for generating wave energy in deep waters incorporated into the production, storage and offloading units, according to an embodiment of the present invention. The method comprises: widening one or more energy extraction chambers 10 arranged on the sides of a floating production, storage and offloading unit, limited to the number of ballast tanks of the unit; removing a bottom plate from the chamber 10 to provide fluid communication between the interior of the chamber 10 and the seawater; making an opening 30 at the top of the chamber 10 for the passage of air flow, with an area reduction of at least 10 times the area of the lower opening 20, limited by the operating speed of the turbine; and assembling an energy generation assembly 40 to convert the air flow from the opening 30 into electrical energy.

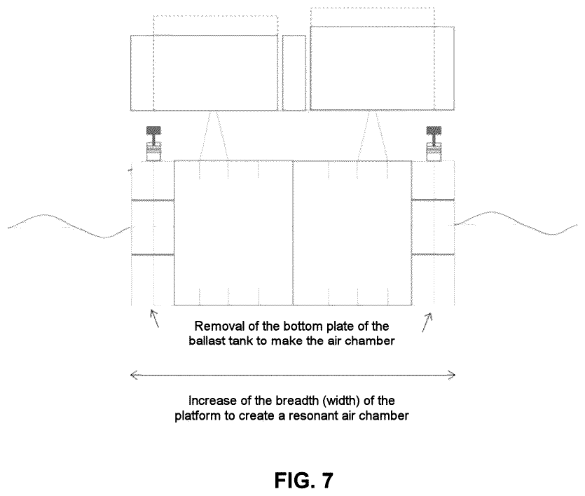

Further, it is worth highlighting that an indirect benefit obtained from widening the breadth (width) of the FPSO-type unit of the system of the present invention is to allow a flatter arrangement of equipment arranged in the process plants 50 of the unit, with an increase in the deck area of between 5 and 15% of the current area, which would allow reducing the height of the plant 50 and the height of the center of gravity of the unit. FIG. 7 shows, by way of example, a comparison between the typical cross section of a FPSO-type floating unit (in dotted lines) and the system of the present invention (in continued lines), resulting from some of the main modifications made, to facilitate visualization of the modifications made.

Those skilled in the art will appreciate the knowledge presented herein and will be able to reproduce the invention in the embodiments presented and in other variants, encompassed by the scope of the attached claims.

1. A system for generating wave energy in deep waters incorporated into floating production, storage and offloading units, the system comprising:
one or more energy extraction chambers arranged on sides of a floating production, storage and offloading unit;
each energy extraction chamber having a lower opening, the lower opening being obtained from removal of a bottom plate of the energy extraction chamber to provide fluid communication between an interior of the energy extraction chamber and seawater;
an upper opening made at a top of the energy extraction chamber for passage of air flow; and
an energy generation assembly for converting the air flow from the upper opening into electrical energy; wherein each energy extraction chamber is obtained from a ballast tank of the production, storage and offloading unit by widening said ballast tank in a direction opposite a center of the floating production, storage and offloading unit to create a resonance condition in the energy extraction chamber, so that a final chamber widening width is determined based on a resonance period of interest of the energy extraction chamber.

2. The system of claim 1, wherein the resonance period of interest of the energy extraction chamber is given as a function of surface area of water inside the energy extraction chamber and of a depth of the water inside the energy extraction chamber, which varies between 10 and 25 meters.

3. The system according to of claim 1, wherein the resonance period of interest of the energy extraction chamber is defined to be a period equal to or close to a period of greatest wave recurrence of a location where the floating production, storage and offloading unit will produce.

4. The system of claim 1, wherein the resonance period of interest of the energy extraction chamber is defined to be a period equal to or close to a resonance period of movements of the floating production, storage and offloading unit.

5. The system of claim 1, wherein a maximum number of energy extraction chambers is limited to a maximum number of ballast tanks of the floating production, storage and offloading unit.

6. The system of claim 1, wherein the upper opening is smaller than the lower opening, so that an area of the upper opening is reduced by at least ten times in relation to an area of the lower opening.

7. The system of claim 1, wherein the energy generation assembly comprises a turbine and a generator.

8. A method of constructing a system for generating wave energy in deep waters incorporated into the floating production, storage and offloading units, as defined in claim 1, the method comprising:
widening one or more energy extraction chambers arranged on the sides of the floating production, storage and offloading unit;
removing a bottom plate from the energy extraction chamber to provide fluid communication between the interior of the energy extraction chamber and the seawater;
making an opening at the top of the energy extraction chamber for the passage of air flow; and
assembling the energy generation assembly for converting the air flow from the opening into electrical energy.
